(19) United States
(12) Patent Application Publication
(10) Pub. No.: US 2007/0197668 A1
(43) Pub. Date: Aug. 23, 2007

(54) Process for preparing polyols

(75) Inventors: Ibrahim Sendijarevic, Royal Oak, MI (US); Vahid Sendijarevic, Troy, MI (US)

Correspondence Address: BROOKS KUSHMAN P.C., 1000 TOWN CENTER, TWENTY-SECOND FLOOR, SOUTHFIELD, MI, 48075, US

(73) Assignee: Troy Polymers, Inc., Troy, MI (US)

(21) Appl. No.: 11/358,453

(22) Filed: Feb. 20, 2006

(51) Int. Cl. C08J 11/04

(52) U.S. Cl. 521/40

(57) ABSTRACT

A process for preparing polyol. The process can include depolymerizing an isocyanate-based material via a depolymerization reaction to obtain a liquid polyol product and treating the liquid polyol product with an adsorbent to remove an impurity from the liquid polyol product. The isocyanate-based material can be an isocyanate-based scrap material.

### BACKGROUND OF THE INVENTION

1. Field of the Invention

One aspect of this invention generally relates to a process for preparing polyols, and more specifically in one aspect, to a process for recycling.

2. Background Art

Depolymerization processes, such as, glycolysis, hydrolysis and aminolysis, can transform solid polyurethane and other isocyanate-based materials into liquid products. Such processes are well known to those skilled in the art and are well documented in numerous technical publications and patents. A comprehensive review of the depolymerization processes has been published by Rasshofer and Weigand [“Automotive Polyurethanes—Advances in Plastics Recycling.” Volume 2, (2001), Technomic Publishing Co., Inc., Lancaster, Pa. 17604, USA, pp. 66-129]. Examples of patents that propose different depolymerization processes for transformation of solid polyurethane and other isocyanate-based scrap materials into liquid products include: U.S. Pat. Nos. 2,937,151; 3,109,824; 3,300,417; 3,404,103; 3,632,530; 3,708,440; 3,738,946; 3,983,087; 4,025,559; 4,044,046; 4,110,266; 4,159,972; 4,316,992; 4,317,939; 4,336,406; 5,300,530; 5,357,006; 5,556,889; 5,635,542; 6,020,386; and 6,750,260.

The source of the solid polyurethane and other isocyanate-based materials for the depolymerization process can be isocyanate-based scrap materials. The scrap materials may contain inorganic and/or organic impurities that may pose environmental and health risks. Therefore, some of the scrap materials are subject to governmental regulations. As a well-documented example, shredder residue and foams recovered from shredder residue can contain polychlorinated biphenyls (PCBs) and heavy metals. The foams (including polyurethane foams) in shredder residue typically originate from the shredding of end-of-life vehicles, which are commonly shredded along with appliances, furniture, industrial, construction and other scrap. In order for the materials and foams recovered from the shredder residue to be reintroduced into United States commerce, they must meet the requirements set by the Environmental Protection Agency (EPA) for substances of concern (SOCs) and heavy metals. As an example, the general rule in the United States is that the materials need to contain less than 2 parts per million (ppm) of PCBs before they are reintroduced into commerce.

Additional examples of regulated and hazardous substances that may be present in the polyurethane and isocyanate-based scrap are brominated fire-retardants, such as pentabromodiphenyl ethers (penta-BDEs) and octabromodiphenyl ethers (octa-BDEs). Some U.S. states prohibit manufacturing, processing and/or distributing in commerce of products with more than one-tenth of 0.1 percent (100 ppm) of penta-BDE or octa-BDE. Penta-BDE has been used in automotive polyurethane seating foams and other automotive polyurethane foam applications and octa-BDE has been used as an additive to acrylonitrile-butadiene-styrene (ABS), which has been used in trim automotive applications [Madsen, T., Lee, S., and Olle, T., “Growing Threats, Toxic Flame retardants and Children's Health”, 2003, Environmental California Research and Policy Center]. Therefore, there is potential that polyurethane foams recovered from shredder residue may contain brominated flame retardants above promulgated regulatory levels. Brominated flame retardants may also be present in bedding foams, mattress foams, foams used in furniture, seating foams, foams used in transportation vehicles, automotive seating foams, seating foams used in public transportation vehicles, appliance foams, construction foams, etc.

Since brominated fire-retardants and PCBs are highly stable compounds, they would not necessarily decompose during the depolymerization reactions of polyurethane and isocyanate-based scrap into liquid compounds. In particular, after depolymerization via glycolysis of isocyanate-based scrap materials contaminated with PCBs, the resulting liquid polyol product also contains PCBs. Therefore, a liquid polyol product of depolymerization may contain PCBs above regulatory levels, and should be further processed to remove and/or reduce the PCBs to an acceptable levels, otherwise the liquid polyol product may be considered as regulated waste. The same additional processing applies to the liquid products of depolymerization that contain other organic and inorganic impurities and SOCs.

It is difficult to economically and effectively remove the impurities and SOCs from the polyurethane and isocyanate-based scrap used as input in depolymerization processes. PCBs are not very soluble in water and therefore are difficult to remove from the scrap by washing with aqueous solutions. U.S. Pat. No. 5,443,157 proposes a system for separating and cleaning polyurethane foam from automotive shredder residue. The foam is washed with water and detergent to remove dirt, grit, oil and grease. This patent does not provide for or suggest the removal of PCBs, penta-BDEs, or heavy metals, which may be present in the foam recovered from shredder residue. In one study, measurable amounts of PCBs were reported in polyurethane foams recovered from shredder residue, even after washing with aqueous solutions via an industrial process [Mark, F. E., “End-of-life Vehicles Recovery and Recycling Polyurethane Seat Cushion Recycling Options Analysis Polyurethane Car Components,” SAE 2004 World Congress, Detroit, Mich., Mar. 8-11, 2004, Paper No. 2004-01-0246].

A method of cleaning polyurethane foam from automobile shredder residue using organic solvents is proposed in U.S. Pat. No. 5,882,432. However, this disclosure is limited to a system for removing organic oils, greases and inorganic dirt from polyurethane foam from automobile shredder residue. This patent does not provide or suggest a process for removal of hazardous impurities or SOCs from the foam, such as, PCBs, penta-BDEs, and heavy metals.

U.S. Pat. No. 6,329,436 proposes a system and process for recycling shredder residue, in which polyurethane foam materials are first separated. This disclosure is limited to cleaning polyurethane foam by treatment with organic solvents to remove automotive fluids and PCBs, which is a costly and inefficient treatment system due to the large amount of solvent that must be used.

The above-identified references do not propose an efficient process for the removal of impurities and hazardous substances from polyurethane and isocyanate-based scrap. Depolymerization processes for the recycling of polyurethane and isocyanate-based scrap into liquid products have not addresses the methods for removal of PCBs, brominated fire retardants, heavy metals, and other regulated and hazardous compounds and impurities that may end-up in the product.

U.S. Pat. No. 4,025,559 proposes a continuous method for converting particulate polyurethane foam via hydrolysis into diamines and liquid polymeric products. This proposal does not provide or suggest a process for producing liquid hydrolysis products free of hazardous and regulated substances that could be present in the polyurethane foams recovered from automobile shredder residues.

U.S. Pat. No. 6,024,226 proposes a system and process for continuous separation, recovery and recycling of all materials from solid wastes and waste streams, such as shredder residue, through use of a liquid media of different specific gravities. The output materials from this separation process are porous product streams, which include flexible foam materials, which are further processed by reacting the output materials with water, glycols and/or amine reactants via chemolysis. This patent does not provide or suggest a process for removing PCBs, penta-BDEs, or heavy metals from the porous product stream before chemolysis (hydrolysis, glycolysis or aminolysis). This patent does not provide or suggest a process for producing liquid hydrolysis products free of hazardous and regulated substances from foams recovered from automobile shredder residues, which might contain these substances.

Glycolysis of mixed flexible foam cushions recovered from end-of-life cars was described with both diethylene glycol (DEG) and dipropylene glycol (DPG). However, a specific requirement for this depolymerization recycling process was that “no dangerous ingredients under regulations concerning hazardous goods” were present in the scrap [Rasshofer and Weigand, “Automotive Polyurethanes—Advances in Plastics Recycling.” Volume 2, (2001), Technomic Publishing Co., Inc., Lancaster, Pa. 17604, USA, p. 101]. Therefore, depending on their source, polyurethane and iscocyanate-based scrap can contain impurities, hazardous substances, and/or regulated substances, which may remain in the liquid products of depolymerization. In addition to PCBs, brominated fire retardants, and heavy metals, the liquid product from the glycolysis of polyurethane foam and isocyanate-based scrap can contain toluene diamines (TDA) or methylenedianiline (MDA), which are suspected carcinogens that require special handling.

In light of the foregoing, it would be advantageous to develop a process for removal of hazardous substances and certain regulated compounds from the liquid products of depolymerization of polyurethane or isocyanate-based scrap, which can come from industrial or post-consumer waste. What is also needed is process for depolymerizing polyurethane and isocyanate-based scrap into liquid polyol product and treating such product with adsorbents to remove PCBs, brominated fire-retardants, and/or other regulated substances and organic and inorganic impurities.

### SUMMARY OF THE INVENTION

According to an embodiment of the present invention, a process for preparing polyol is disclosed. The process includes the steps of depolymerizing an isocyanate-based material via a depolymerization reaction to obtain a liquid polyol product; and treating the liquid polyol product with an adsorbent to remove an impurity from the liquid polyol product. The isocyanate-based material is an isocyanate-based scrap material. The impurity can be an organic impurity or an inorganic impurity. The treating step can be carried out one or more times. The treating step can include charging the adsorbent into the liquid polyol product. The treating step can include passing the liquid polyol product through a column packed with the adsorbent.

In certain embodiments, the depolymerization reaction is a glycolysis reaction. The glycolysis reaction can include the use of a glycol-based compound or a hydroxyl-containing compound. The ratio of the isocyanate-based material to the glycol-based compound can be between 1:4 and 15:1. The glycol-based compound can be selected from the following group: dipropylene glycol, diethylene glycol, propylene glycol, ethylene glycol and mixtures thereof. The glycolysis reaction can include the use of a catalyst, and the catalyst can be selected from the following group: sodium hydroxide, potassium hydroxide, sodium alcoholate, potassium alcoholate and mixtures thereof.

In certain embodiments, the polyol producing process can include the step of separating the isocyanate-based scrap material from a shredder residue material, and the isocyanate-based scrap material can be substantially comprised of an isocyanate-based foam scrap material. The separating step can be carried out via an automated process or a manual process. The polyol producing process can further include the step of washing the isocyanate-based foam scrap material with an aqueous solution or an organic solvent; and/or drying the isocyanate-based form scrap material prior to depolymerization.

The isocyanate-based scrap material can be selected from the following group: bedding foam scrap, foams from mattresses, foams from furniture, seating foams, foams used in transportation vehicles, seating foams used in automobiles, seating foams used in public transportation vehicles, foams from construction, foams from appliances and mixtures thereof.

In certain embodiments, the polyol producing process can include the step of mixing the absorbent and the liquid polyol product for a predetermined mixing time, and removing the charged absorbent from the liquid polyol via a filtration process or a separation process after the predetermined mixing time has elapsed.

In certain embodiments, the ratio of the adsorbent to the liquid polyol product can be between 1:1 and 1:999. The adsorbent can be an activated carbon. The treating step can include introducing a diluent into the liquid polyol product. Certain processes of the present invention can include substantially removing the diluent from the liquid polyol product.

The organic impurity can be selected from the following group: polychlorinated biphenyls, brominated fire retardants, toluene diamines and methylenedianiline. The inorganic impurity can be a heavy metal.

The depolymerizing step can include introducing a mixture of at least two of the following reactants: glycols, amines and water. The depolymerization reaction can be an aminolysis reaction. The depolymerization reaction can be a hydrolysis reaction.

In certain embodiments, the polyol producing process can include the step of producing a polyurethane with the liquid polyol product. The polyurethane can be a cellular polyurethane or a non-cellular polyurethane.

In certain embodiments, the polyol producing process can include the step of chemically modifying the liquid polyol product to modify a chemical property of the liquid polyol product. The chemical property can be selected from the following group: equivalent weight, functionality, molecular weight distribution and reactivity.

According to another embodiment of the present invention, a process for preparing polyol is disclosed. The process includes depolymerizing an isocyanate-based scrap material including a solid scrap component via a depolymerization reaction to obtain a liquid polyol product; filtering the liquid polyol product to remove the solid scrap component; and treating the liquid polyol product with an adsorbent to remove an impurity from the liquid polyol product. In certain embodiments, the solid scrap component is unpolymerizable.

In another embodiment, the polyol product is made by a process comprising the following steps: depolymerizing an isocyanate-based material via a depolymerization reaction to obtain a polyol product; and treating the liquid polyol product with an adsorbent to remove an impurity from the polyol product.

### DETAILED DESCRIPTION OF EMBODIMENTS

Except where expressly indicated, all numerical quantities in this description indicating amounts of material or conditions of reaction and/or use are to be understood as modified by the word “about” in describing the broadest scope of the present invention. Practice within the numerical limits stated is generally preferred.

The description of a single material, compound or constituent or a group or class of materials, compounds or constituents as suitable for a given purpose in connection with the present invention implies that mixtures of any two or more single materials, compounds or constituents and/or groups or classes of materials, compounds or constituents are also suitable. Also, unless expressly stated to the contrary, percent, “parts of”, and ratio values are by weight. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

In certain embodiments, the present invention relates to a depolymerization process for recycling of scrap containing aromatic isocyanate-based materials and removing impurities from the product of depolymerization. The process can be used for recycling of practically any type of isocyanate-based scrap, including aromatic isocyanate-based scrap, such as post-consumer isocyanate-based material scrap, industrial isocyanate-based scrap, mixtures of different types of isocyanate-based material scrap, or mixtures of isocyanate-based scrap with other materials. For example, the aromatic isocyanate-based material scrap can be a cellular or solid polyurethane monoscrap or a polyurethane-containing composite material. The source of this scrap can be industrial or post-consumer scrap from automotive trim parts or transportation vehicles. Without limitation, the source of suitable aromatic isocyanate-based material scrap can also include bedding foams, foams separated from mattresses, foams used in furniture, seating foams, foams used in transportation vehicles, seating foams used in automobiles, seating foams used in public transportation vehicles, and foams used in appliances and construction. In one embodiment, the scrap is a foam stream containing isocyanate-based materials and isocyanate-based foams separated from shredder residue. The foams in shredder residue mostly originate from the shredding of the end-of-life vehicles, which are often shredded with appliances, furniture, industrial, construction, transportation, and other scrap. The foam stream containing isocyanate-based materials can be separated from the shredder residue via an automated separation process or manually. Prior to the depolymerization step, the separated foam stream containing isocyanate-based scrap can be, but does not necessarily have to be, washed with aqueous solutions or with solvent-based solutions to remove some impurities.

In a first stage of the process according to one embodiment of the present invention, isocyanate-based material scrap is depolymerized to produce liquid polyol products. The depolymerization reactions produce liquid products, which can be composed primarily from polyols, but other materials can be present, which include, but are not limited to, amines, residual reactants, catalysts, and organic and inorganic impurities. Thus, the term “polyol product”, as used in certain embodiments herein, is meant to include the polyol products without excluding any other material which may be present in the liquid products of depolymerization. The polyol product from depolymerization can be used in reaction with isocyanates for preparation of cellular and non-cellular isocyanate-based polymers, including polyurethanes, with or without further modifications.

The depolymerization reaction can be any reaction suitable for depolymerizing the isocyanate-based materials, such as hydrolysis, aminolysis, or glycolysis. In one embodiment, the depolymerization reaction is glycolysis. Any suitable hydroxyl-containing compound or glycol can be used in the glycolysis reaction. In certain embodiments, the glycol is a low molecular weight glycol such as dipropylene glycol, diethylene glycol, ethylene glycol, or mixtures of these glycols. In addition to virgin glycols, recycled glycols can also be used in glycolysis, such as glycols recovered from antifreeze and coolants. Any suitable catalyst can be used in the glycolysis reactions, which include, but are not limited to, sodium hydroxide, potassium hydroxide, sodium alcoholate, potassium alcoholate, or mixtures thereof.

In certain embodiments, the weigh ratio of isocyanate-containing scrap to glycol used in glycolysis depolymerization reaction is between about 1:4 and about 15:1. In certain embodiments, glycol is charged to a reactor with a catalyst, the mixture is agitated and heated to a selected temperature, and isocyanate-containing scrap is charged continuously or in intervals to the mixture under agitation. The addition rate of scrap can be controlled to ensure that the mixture inside the reactor remains mostly liquid. As needed, the processing temperature can be increased during the addition of scrap. After the scrap charge is completed, the mixture can be further aged at a selected temperature. After the age period is completed, the polyol product temperature can be decreased to a selected temperature, which can be room temperature.

The polyol product can be filtered to remove inorganic and organic solid materials that were not depolymerized in the glycolysis reaction. Filtration can be completed at room temperature or at an elevated temperature. At elevated temperatures, the viscosity of the polyol product is typically lower, which typically enhances the filtration rate. In addition to increasing the temperature, the filtration rate of the polyol product can be improved through the addition of diluents, which can be water and/or an organic solvent. Without limitation, filtration can be completed using a conventional bag filter, a cyclone separator, disk filters equipped for continuous removal of solids, filter press, or any filtration method known to those skilled in the art. The filtration unit can be placed in a recycle loop with the reactor or a tank holding the polyol product.

In a second stage of the process according to certain embodiments, the polyol products are treated with adsorbents to remove small organic molecules and/or inorganic impurities from the polyol products. Without limitation, small organic molecules that can be removed from the polyol products include PCBs, brominated fire retardants, TDA and MDA. Various natural and synthetic adsorbents can be used for treatment of the polyol products. Adsorbents can include polyolefin materials and soft plastics, such as rubbers, including rubber from shredded tires. In a certain embodiment, activated carbon adsorbents are used. Activated carbons can be granular or powdered. Granular activated carbon can be used according to certain embodiments.

In at least one embodiment, activated carbons are charged to the polyol product, wherein the polyol product with activated carbon is mixed under agitation. Based on the polyol product weigth, 1 to 40 weight percent of activated carbon can be charged to the polyol product. Activated carbon adsorbent can be removed from the polyol product via filtration or separation techniques. Without limitation, filtration or separation can be completed using a conventional bag filter, a cyclone separator, disk filters equipped for continuous removal of solids, filter press, or any filtration method known to those skilled in the art. This process can be repeated one or more times. The filtration unit can be placed in a recycled loop with the reactor or a tank holding the polyol products.

In certain instances, before or after the adsorbent addition, diluents can be added to the polyol product. Non-limiting examples of diluents include water and/or organic solvents. After the final removal of adsorbent from polyol products, the diluents can be removed from the polyol product via evaporation or separation methods known to those skilled in the art.

Polyol products, with or without diluents, can also be treated with adsorbents by passing the polyol products through a column packed with an adsorbent. If a diluent is present in the polyol products after it was passed through a column, it can be removed from the polyol product via evaporation or separation methods known to those skilled in the art.

The polyol product, treated with adsorbents, can be used in reactions with isocyanates for preparation of cellular and non-cellular isocyanate-based polymers, including polyurethanes. The polyol product can also be chemically modified to change its functionality, equivalent weight, molecular weight dispersion, and reactivity. An example of chemical modification is oxyalkylation.

The following non-limiting examples demonstrate the use of adsorbents in the preparation of polyol products.

### EXAMPLES

In these examples, two lots of foam scrap recovered from shredder residue were used as raw materials for depolymerization. Both lots of foam scrap were recovered from shredder residue via automated separation processes. The first lot of foam scrap (Lot #1) was recovered from shredder residue via an industrial automated separation process and the foam scrap was subsequently washed with an aqueous cleaner and dried as part of the industrial process. The second lot of foam scrap was separated from shredder residue via a pilot automated separation process without any further cleaning (Lot #2).

Both lots of foam scrap were heterogeneous in composition, however their compositions appeared to be mostly mixtures of different aromatic-based polyurethane foams, however, a small amount of non-polyurethane foams were present as well. In addition to stand-alone pieces of foam, foams laminated with plastics and/or textile were present in the foam scrap. For the depolymerization via glycolysis, the foams were cut into particles of about 1-4 cm diameter.

It was determined that the Lot #1 and Lot #2 foam scrap contained about 20 parts per million (ppm) to about 40 ppm of PCBs, as determined by a certified analytical laboratory, University Laboratories of Novi, Mich.

The analyses of Lot #1 foam scrap performed by a certified analytical laboratory, Galbraith Laboratories of Knoxville, Tenn., indicate about 46 ppm to about 70 ppm levels of bromine. The analyses of Lot #2 foam scrap performed by the certified analytical laboratory indicate about 240 ppm level of bromine. The presence of bromine indicates that it is possible that brominated fire retardants are present in the foam scrap, however, there is a possibility that the detected bromine was not necessarily associated with the brominated fire retardants.

Foam scrap was also analyzed for the presence of selected metals by a certified analytical laboratory, Midwest Analytical Services, Inc. of Ferndale, Mich. The concentration of metals is summarized in Table 1. Lot #1 foam scrap, which was washed, contained lower levels of heavy metals than Lot #2 scrap, which was unwashed. Therefore, it appears that simple washing, removes significant levels of inorganic impurities from foam scrap, however, measurable levels of several heavy metals remained.

TABLE 1

| | Foam scrap Lot #1 | Foam Scrap Lot #2 |
|---|---|---|
| Designation | ppm | ppm |
| Arsenic | N/D | N/D |
| Barium | 5.1 | 290 |
| Cadmium | N/D | 16 |
| Chromium | 3.2 | 92 |
| Copper | 14 | 650 |
| Lead | 97 | 1300 |
| Mercury | 0.11 | N/D |
| Selenium | N/D | N/D |
| Silver | N/D | N/D |
| Zinc | 340 | 6600 |

### Example #1

The depolymerization reaction was carried out in a 4 L reactor, equipped with nitrogen sweep, mechanical agitator, thermocouple, temperature controller, and heating mantle. The depolymerization of Lot #2 foam scrap into polyol product was carried out via glycolysis reaction. Dipropylene glycol (DPG) was used with sodium hydroxide (KOH) as a catalyst. 2.16 lbs of DPG were charged to the reactor with 25 g of KOH. The liquid mixture was heated under agitation to approximately 302° F. and while maintaining the temperature under agitation foam scrap was slowly charged into the reactor. Temperature of the liquid mixture was subsequently increased to 356° F. and the foam scrap was continuously added to the liquid mixture. The total amount of foam charged was 3.24 lbs. Temperature of the liquid mixture was subsequently increased to about 392° F. and the mixture was aged under agitation for approximately 60 minutes. Subsequently, the liquid mixture was cooled to room temperature and strained through a metal strainer.

3.71 lbs of the liquid product was removed from the reactor, resulting in an overall yield of over 69%.

The resulting polyol product had a room temperature viscosity of 7,500 centapoise.

The analyses, performed at a certified analytical laboratory yielded PCB levels in the polyol product of 19 parts per million (ppm). Therefore, PCBs present in Lot #2 foam scrap were not eliminated in the depolymerization reaction.

The analyses, performed at a certified analytical laboratory yielded bromine levels in the polyol product of 130 ppm. The data indicates that it is possible that brominated fire retardants are present in the polyol product, however, there is a possibility that the detected bromines were not necessarily associated with the brominated fire retardants.

### Example #2

The depolymerization reaction was carried out in a 5 gallon reactor, equipped with nitrogen sweep, mechanical agitator, thermocouple, temperature controller, and heating mantle. The depolymerization of Lot #1 foam scrap into polyol product was carried out via glycolysis reaction. Dipropylene glycol (DPG) was used with sodium hydroxide (NaOH) as a catalyst. 16.6 lbs of DPG were charged to the reactor with 190 g of NaOH. The liquid mixture was heated under agitation to approximately 302° F., and while maintaining the temperature under agitation 10 lbs of foam scrap was slowly charged into the reactor over approximately 60 minutes. The temperature of the liquid mixture was subsequently increased to 356° F. and an additional 15 lbs of foam scrap were slowly charged to the reactor over approximately 60 minutes. Temperature of the liquid mixture was subsequently increased to about 392° F. and the mixture was aged under agitation for approximately 120 minutes. Subsequently, the liquid mixture was cooled to room temperature and strained through a metal strainer.

39.0 lbs of the liquid product was removed from the reactor, resulting in an overall yield of over 93.8%.

The polyol product was charged back into a 5 gallon reactor. A bag filter equipped with a 150 micron mesh filter bag was connected to a reactor via a diaphragm pump. The polyol product was pumped from a reactor through a filter into a clear container. A filtration yield of 93.0% was obtained.

The resulting polyol product has a room temperature viscosity of 3,800 centapoise.

The hydroxyl number was determined at 341 mg KOH/g.

The analyses, performed at a certified analytical laboratory yielded PCB levels in the polyol product of 14 parts per million (ppm). Therefore, PCBs present in the foam scrap were not eliminated in the depolymerization reaction.

The analyses, performed at a certified analytical laboratory yielded bromine levels in the polyol product of 27 ppm. The data indicates that it is possible that brominated fire retardants are present in the polyol product, however, there is a possibility that the detected bromines were not necessarily associated with the brominated fire retardants.

### Example #3

The depolymerization reaction was carried out in a 2 liter reactor, equipped with nitrogen sweep, mechanical agitator, thermocouple, temperature controller, and heating mantle. The depolymerization of Lot #1 foam scrap into polyol product was carried out via glycolysis reaction. Diethylene glycol (DEG) was used with potassium hydroxide (KOH) as a catalyst. 531 g of DEG were charged to the reactor with 13.3 g of KOH. The liquid mixture was heated under agitation to approximately 302° F., and 797 g of foam scrap was slowly charged to the reactor. During the foam scrap charge, the mixture temperature was gradually increased to about 356° F. After all of foam scrap was charged the liquid mixture was heated to about 392° F. and aged for about 60 minutes. Subsequently, the liquid mixture was cooled to room temperature and strained through a metal strainer.

The analyses, performed at a certified analytical laboratory yielded PCB levels in the polyol product of 28.7 parts per million (ppm). Therefore, PCBs present in the foam scrap were not eliminated in the depolymerization reaction.

150 g of polyol product was mixed with 150 g of acetone and to this mixture 15 g of Aquasorb 1500 activated carbon was added. Mixture was agitated for approximately 60 minutes and activated carbon was removed via filtration through a filter paper. An additional 15 g of Aquasorb 1500 activated carbon was charged to the polyol product/acetone mixture and the procedure was repeated. Overall, five (5) activated carbon treatments were performed. Acetone was removed from polyol product via evaporation.

The analyses, performed at a certified analytical laboratory yielded non-detectable PCB levels in the polyol product treated with activated carbon. Therefore, this result indicates that the treatment with activated carbons can remove PCBs from the polyol product.

The polyol product treated with activated carbon was also analyzed for metals by a certified analytical laboratory. As the data in Table 2 shows, with the exception of zinc, treatment with activated carbons removed all the metals from the polyol product to non-detectable (N/D) levels.

TABLE 2

| | | Polyol Product Treated |
|---|---|---|
| | Foam scrap Lot #1 | w/AC |
| Designation | ppm | ppm |
| Arsenic | N/D | N/D |
| Barium | 5.1 | N/D |
| Cadmium | N/D | N/D |
| Chromium | 3.2 | N/D |
| Copper | 14 | N/D |
| Lead | 97 | N/D |
| Mercury | 0.11 | N/D |
| Selenium | N/D | N/D |
| Silver | N/D | N/D |
| Zinc | 340 | 22 |

### Example #4

The depolymerization reaction was carried out in a 5 gallon reactor, equipped with nitrogen sweep, mechanical agitator, thermocouple, temperature controller, and heating mantle. The depolymerization of Lot #1 foam scrap into polyol product was carried out via glycolysis reaction. Diethylene glycol (DEG) was used with potassium hydroxide (KOH) as a catalyst. 16.6 lbs of DEG were charged to the reactor with 190 g of KOH. The liquid mixture was heated under agitation to approximately 302° F., and while maintaining the temperature under agitation, 10 lbs of foam scrap was slowly charged into reactor over approximately 60 minutes. Temperature of the liquid mixture was subsequently increased to 356° F. and an additional 15 lbs of foam scrap were slowly charged to the reactor over approximately 60 minutes. The temperature of the liquid mixture was subsequently increased to about 392° F. and the mixture was aged under agitation for approximately 120 minutes. The liquid mixture was cooled to room temperature and strained through a metal strainer.

41.0 lbs of the liquid product was removed from the reactor, resulting in an overall yield of over 98.5%.

The polyol product was mixed on equal bases with acetone and to this mixture 10% of Aquasorb 1500 activated carbon was added, based on polyol product weight. The mixture was agitated and the activated carbon removed via filtration through a strainer. 10% of Aquasorb 1500 activated carbon, based on the initial polyol product weight, was charged and the procedure repeated. Overall, five (5) activated carbon treatments were performed. Acetone was removed from polyol product via evaporation.

The analyses, performed at a certified analytical laboratory yielded non-detectable PCB levels in the polyol product. As Lot #1 foam scrap used in depolymerization contained about 20 to 40 ppm of PCBs, this result indicates that the treatment with activated carbons can be removed PCBs from the resulting polyol product.

The analyses, performed at a certified analytical laboratory yielded non-detectable bromine levels. The non-detectable levels of bromine indicate the possibility that brominated fire retardants were removed from the polyol product via treatment with activated carbon. This result indicates that the treatment with actuated carbon can remove PCBs from the resulting polyol product.

As required, detailed embodiments of the present invention are disclosed herein. However, it is to be understood that the disclosed embodiments are merely exemplary of an invention that may be embodied in various and alternative forms. While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

In accordance with the provisions of the patent statute, the principle and mode of operation of this invention have been explained and illustrated in its various embodiments. However, it must be understood that this invention may be practiced otherwise than as specifically explained and illustrated without departing from its spirit or scope.

What is claimed is:

1. A process for preparing polyol comprising:
depolymerizing an isocyanate-based material via a depolymerization reaction to obtain a liquid polyol product; and
treating the liquid polyol product with an adsorbent to remove an impurity from the liquid polyol product.

2. The process of claim 1, wherein the isocyanate-based material is an isocyanate-based scrap material.

3. The process of claim 1, wherein the impurity is an organic impurity or an inorganic impurity.

4. The process of claim 1, wherein the depolymerization reaction is a glycolysis reaction.

5. The process of claim 4, wherein the glycolysis reaction includes the use of a glycol-based compound or a hydroxyl-containing compound.

6. The process of claim 4, wherein the glycolysis reaction includes the use of a glycol-based compound.

7. The process of claim 6, wherein the ratio of the isocyanate-based material to the glycol-based compound is between 1:4 and 15:1.

8. The process of claim 6, wherein the glycol-based compound is selected from the group consisting of dipropylene glycol, diethylene glycol, propylene glycol, ethylene glycol and mixtures thereof.

9. The process of claim 4, wherein the glycolysis reaction includes the use of a catalyst, the catalyst is selected from the group consisting of sodium hydroxide, potassium hydroxide, sodium alcoholate, potassium alcoholate and mixtures thereof.

10. The process of claim 2, further comprising separating the isocyanate-based scrap material from a shredder residue material, the isocyanate-based scrap material is substantially comprised of a isocyanate-based foam scrap material.

11. The process of claim 10, wherein the separating step is carried out via an automated process or a manual process.

12. The process of claim 10, further comprising washing the isocyanate-based foam scrap material with an aqueous solution or an organic solvent.

13. The process of claim 12, further comprising drying the isocyanate-based foam scrap material prior to depolymerization.

14. The process of claim 2, wherein the isocyanate-based scrap material is selected from the group consisting of: bedding foam scrap, foams from mattresses, foams from furniture, seating foams, foams used in transportation vehicles, seating foams used in automobiles, seating foams used in public transportation vehicles, foams from construction, foams from appliances and mixtures thereof.

15. The process of claim 1, wherein the treating step includes charging the adsorbent into the liquid polyol product.

16. The process of claim 15, further comprising mixing the absorbent and the liquid polyol product for a predetermined mixing time, and removing the charged absorbent from the liquid polyol via a filtration process or a separation process after the predetermined mixing time has elapsed.

17. The process of claim 1, wherein the treating step includes passing the liquid polyol product through a column packed with the adsorbent.

18. The process of claim 1, wherein the ratio of the adsorbent to the liquid polyol product is between 1:1 and 1:999.

19. The process of claim 1, wherein the adsorbent is an activated carbon.

20. The process of claim 1, wherein the treating step includes introducing a diluent into the liquid polyol product.

21. The process of claim 20, further comprising substantially removing the diluent from the liquid polyol product.

22. The process of claim 3, wherein the organic impurity is selected from the group consisting of: polychlorinated biphenyls, brominated fire retardants, toluene diamines and methylenedianiline.

23. The process of claim 3, wherein the inorganic impurity is a heavy metal.

24. The process of claim 1, wherein the depolymerizing step includes introducing a mixture of at least two reactants selected from the group consisting of: glycols, amines and water.

25. The process of claim 1, wherein the depolymerization reaction is an aminolysis reaction.

26. The process of claim 1, wherein the depolymerization reaction is a hydrolysis reaction.

27. The process of claim 1, wherein the treating step is carried out one or more times.

28. The process of claim 1, further comprising producing a polyurethane with the liquid polyol product.

29. The process of claim 28, wherein the polyurethane is a cellular polyurethane or a non-cellular polyurethane.

30. The process of claim 1, further comprising chemically modifying the liquid polyol product to modify a chemical property of the liquid polyol product.

31. The process of claim 30, wherein the chemical property is selected from the group consisting of: equivalent weight, functionality, molecular weight distribution and reactivity.

32. A process for preparing polyol comprising:
depolymerizing an isocyanate-based scrap material including a solid scrap component via a depolymerization reaction to obtain a liquid polyol product;
filtering the liquid polyol product to remove the solid scrap component; and
treating the liquid polyol product with an adsorbent to remove an impurity from the liquid polyol product.

33. The process of claim 32, wherein the solid scrap component is unpolymerizable.

34. A polyol product made by a process comprising the following steps:
depolymerizing an isocyanate-based material via a depolymerization reaction to obtain a polyol product; and
treating the liquid polyol product with an adsorbent to remove an impurity from the polyol product.
